(19) United States
(12) Patent Application Publication
(10) Pub. No.: US 2011/0038777 A1
(43) Pub. Date: Feb. 17, 2011

(54) PRODUCTION METHOD OF WATER GLASS

(76) Inventors: Jiro Kondo, Tokyo (JP); Nobuyuki Ono, Tokyo (JP); Hiroshi Onodera, Osaka (JP); Tsutomu Saito, Osaka (JP)

Correspondence Address: KENYON & KENYON LLP, ONE BROADWAY, NEW YORK, NY, 10004, US

(21) Appl. No.: 12/736,324

(22) PCT Filed: Apr. 3, 2009
(86) PCT No.: PCT/JP2009/057301

§ 371 Date: Sep. 28, 2010

(30) Foreign Application Priority Data
Apr. 4, 2008 (JP) 2008-098620
Dec. 3, 2008 (JP) 2008-308783

(51) Int. Cl. C01B 33/32

(52) U.S. Cl. 423/332

(57) ABSTRACT

The present invention relates to a production method, of water glass, comprising dissolving a sodium-based byproduct which is by-produced in the process of enhancing the purity of silicone and not only contains silicon but also contains sodium silicate as a main component, in water to produce crude water glass, at the same time, dissolving the silicon to generate a hydrogen gas, and then filtering the crude water glass to produce water glass.

An object of the present invention is to provide a production method of water glass, ensuring that in utilizing, as water glass, a sodium-based byproduct which is by-produced in the process of enhancing the purity of silicon and not only contains silicon but also contains sodium silicate as a main component, the problem of hydrogen gas generation attributable to silicon contained in the byproduct can be solved, a safe and stable operation is possible, and effective utilization as transparent water glass can be achieved.

### TECHNICAL FIELD

The present invention relates to a production method of water glass using a byproduct which is by-produced in the process of enhancing the purity of silicon and not only contains silicon but also contains sodium silicate as a main component. More specifically, the present invention relates to a production method of water glass using a byproduct which is by-produced in the production of silicon from an SiO solid or in the course of removing boron by slag refining from silicon and not only contains silicon but also contains sodium silicate as a main component.

### BACKGROUND ART

The present inventors have previously disclosed in Kokai (Japanese Unexamined Patent Publication) No. 2005-247623 (Patent Document 1) a method for removing boron from silicon, characterized in that a metal silicon containing boron as an impurity is heated to a temperature not lower than the melting point to form a melted state and a solid based on silicon dioxide and a solid based on either one or both of an alkali carbonate and a hydrated alkali carbonate are added to the molten silicon, thereby forming a slag and at the same time, removing boron in the silicon. As the alkali carbonate or hydrated alkali carbonate, sodium compounds, i.e., sodium carbonate, sodium hydrogencarbonate and hydrated salts thereof, are set forth.

Also, the present inventors have disclosed in Kokai No. 2004-51453 (Patent Document 2) a production method of Si, characterized by adding any one of oxides, hydroxides, carbonates and fluorides of an alkali metal element, any one of oxides, hydroxides, carbonates and fluorides of an alkaline earth metal element, or two or more of these compounds to an SiO solid, heating the produced mixture at a temperature not lower than the melting point of Si to cause a chemical reaction and thereby produce Si, and separating/recovering the Si from reaction byproducts. In this method, sodium is set forth as one of alkali metal elements.

The present invention has a relationship with these two methods where a sodium compound is used.

In the case of using a sodium compound in the method for removing boron from silicon, a glassy substance based on SiO₂ and sodium oxide, i.e., a byproduct based on sodium silicate, is generated in addition to silicon. Also, in the case of using a sodium compound in the method for producing silicon from an SiO solid, a glassy substance composed of SiO₂ and sodium oxide produced from the sodium compound added, i.e., a byproduct based on sodium silicate, is generated in addition to silicon. These byproducts are generated in a weight equal to or greater than the weight of silicon, and a method for effective utilization thereof is demanded.

### RELATED ART

### Patent Document

(Patent Document 1) Kokai No. 2005-247623

(Patent Document 2) Kokai No. 2004-51453

### Non-Patent Document

(Non-Patent Document 1)

Teizo Tsuchiya, et al., Journal of the Japan Society of Waste Management Experts, Vol. 16, No. 6, pp. 540-544, 2005

### SUMMARY OF THE INVENTION

### Problems to be Solved by the Invention

As stated in the BACKGROUND ART, in the method for producing silicon from an SiO solid described in Kokai No. 2004-51453 (Patent Document 2), a glassy substance composed of SiO₂ and an oxide of an alkali element or alkaline earth element added is by-produced in addition to silicon, and the present invention provides an effective utilization method of a byproduct containing sodium silicate as a main component, which is by-produced when sodium is selected as the alkali element or alkaline earth element. Also, the present invention provides an effective utilization method of a byproduct containing sodium silicate as a main component, which is, as stated in BACKGROUND ART, by-produced other than silicon in the method for removing boron from silicon described in Kokai No. 2005-247623 (Patent Document 1).

In the following, these byproducts are referred to as a “sodium-based byproduct”.

The sodium-based byproduct contains sodium silicate as a main component and therefore, has a possibility of utilization as a raw material of water glass.

The water glass as used herein is a colorless transparent aqueous solution mainly composed of sodium silicate and indicates an aqueous solution having a turbidity (JIS-K0101, Industrial Water Test Method) of, for example, 15 or less, which is an industrial product generally used for building or construction materials (e.g., soil stabilizer, cement accelerator), molding materials (e.g., casting sand mold material), raw materials for production of silicic anhydride (e.g., white carbon, silica gel, silica support for catalyst), pulp materials (e.g., bleaching agent), binder components (for ceramic or adhesive), and the like.

General industrial production methods of water glass are roughly classified into a dry process and a wet process. In the dry process, the water glass is produced by mixing raw silica sand and raw soda ash, melting the mixture, and cooling/solidifying the melt, where a colorless transparent sodium silicate solid called cullet is melted by heating it together with water under pressure in an autoclave to form an aqueous solution. This aqueous solution is sometimes referred to as crude water glass.

The crude water glass contains a slight amount of insoluble components in some cases. Therefore, in a general method, after the autoclave treatment, a filter aid such as diatomaceous earth is added, if desired, to the crude water glass to remove insoluble components by filtration, and only a transparent aqueous solution is separated and used as a water glass product.

However, when water glass is produced by the method above by using a sodium-based byproduct as a raw material, the following problems are involved.

First, as described above, the sodium-based byproduct is by-produced in the production method of silicon and therefore, contains a slight amount of silicon in almost all cases, and a silicon slug of several mm to several tens of mm in size is nipped in places of the sodium-based byproduct. This mode may not be present depending on the conditions in producing the sodium-based byproduct.

Also, in the method of producing silicon from an SiO solid or in the method for removing boron by slag refining from silicon, although the generation source is unclear, impurities (sometimes referred to as contaminants) from a refractory lining, a member, a humidity retention material and the like are dissolved or mixed in a small amount in the sodium-based byproduct.

The crude water glass is strongly alkaline and therefore, the contaminants (e.g., Al₂O₃, MgO, CaO) from a refractory liner, a member, a humidity retention material and the like dissolve even in a small amount. The dissolved polyvalent metal ion in a small amount, such as Ca, Mg and Al, reacts with sodium silicate in the crude water glass and is simultaneously gelled by producing an insoluble hydrated metal silicate, silicic acid and the like, which also gives rise to a suspended matter in the crude water glass. For example, the reaction with calcium hydroxide proceeds as in (formula 1):

Na₂O.nSiO₂+Ca(OH)₂+mH₂O→CaO.nSiO₂.mH₂O.2NaOH (partially becomes SiO₂) (formula 1)

The sodium-based byproduct containing silicon is brown or gray unlike the cullet for normal water glass raw material and when this is dissolved in water to form an aqueous solution, a dark brown or gray liquid is obtained due to the suspended matter produced. Furthermore, the suspended matter is in many cases a fine particle of 1 μm or less and produces strong turbidity, and this is presumed to make the filtration difficult.

Considering industrial production, production of defective turbid water glass is a problem and when a defect is produced, its disposal is expensive and time consuming. For this reason, it has been considered difficult to use the sodium-based byproduct as a water glass raw material.

Secondly, when the sodium-based byproduct is dissolved in water at a high temperature, the solution becomes alkaline due to sodium silicate, and silicon in an alkaline solution is known to react with water to generate hydrogen. This phenomenon is described, for example, in Teizo Tsuchiya, et al., Journal of the Japan Society of Waste Management Experts, Vol. 16, No. 6, pp. 540-544, 2005 (Non-Patent Document 1). Hydrogen is an explosive gas and when for using the sodium-based byproduct on an industrial production line, it is necessary to take precautions. Also, even if hydrogen is generated in a small amount and the amount of hydrogen generated is not large enough to cause an explosion, the pressure greatly rises during dissolution in an autoclave and, for example, the liquid as the content flows out from a gas relief valve, becomes unstable.

By taking these problems into consideration, an object of the present invention is provide a production method of water glass, ensuring that a byproduct by-produced in the process of enhancing the purity of silicon and not only containing silicon but also containing sodium silicate as a main component (sodium-based byproduct) can be recycled as water glass, the problem of hydrogen gas generation due to silicon in the sodium-based byproduct can be solved to enable a safe and stable operation, and effective utilization as a transparent water glass is achieved.

### Means to Solve the Problem

The characteristic features of the present invention are as follows.

(1) A production method of water glass, comprising dissolving a sodium-based byproduct which is by-produced in the process of enhancing the purity of silicone and not only contains silicon but also contains sodium silicate as a main component, in water to produce crude water glass, at the same time, dissolving the silicon to generate a hydrogen gas, and then filtering the crude water glass to produce water glass.

(2) The production method of water glass as described in (1) above, comprising dissolving a sodium-based byproduct which is by-produced in the process of enhancing the purity of silicone and not only contains silicon but also contains sodium silicate as a main component, in water to produce crude water glass, at the same time, dissolving the silicon to generate a hydrogen gas, and then filtering the crude water glass by using a filter aid to produce water glass.

(3) The production method of water glass as described in (1) or (2) above, wherein the sodium-based byproduct is a byproduct which is by-produced in a method for removing boron from silicon by melting under heating metal silicon containing boron as an impurity and adding a solid based on silicon dioxide and a solid based on either one or both of sodium carbonate and hydrated sodium carbonate to the molten silicon to form a slag containing sodium silicate as a main component and at the same time, remove boron in the molten silicon by its transfer to the slag, and which comprises the slag.

(4) The production method of water glass as described in (1) or (2) above, wherein the sodium-based byproduct is a byproduct which is by-produced in a method for producing Si by adding any one of oxides, hydroxides, carbonates and fluorides of sodium or two or more of these compounds to an SiO solid to obtain a mixture and heating the mixture at a temperature not lower than the melting point of Si to produce Si.

(5) The production method of water glass as described in (1) to (4) above, wherein the sodium-based byproduct when dissolving it in water is dissolved under atmospheric pressure, the produced aqueous solution is left standing still, an undissolved sodium-based byproduct is precipitated and separated, and the aqueous solution after the separation is used as the crude water glass.

(6) The production method of water glass as described in (5) above, wherein the aqueous solution after the separation of an undissolved sodium-based byproduct is heated at 60 to 250° C. to aggregate suspended matters produced in the aqueous solution at the dissolution, the suspended matter is separated, and the aqueous solution after the separation is used as the crude water glass.

(7) The production method of water glass as described in (1) to (4) above, wherein the sodium-based byproduct when dissolving it in water is dissolved under atmospheric pressure, the produced aqueous solution is heated at 60 to 250° C. to aggregate suspended matters produced in the aqueous solution at the dissolution, the suspended matter and an undissolved sodium-based byproduct are separated, and the aqueous solution after the separation is used as the crude water glass.

(8) The production method of water glass as described in (6) or (7) above, wherein still standing or centrifugal separation is used as the method for separating the suspended matter.

(9) The production method of water glass as described in (1) to (8) above, wherein when dissolving the silicon to generate a hydrogen gas, silicon floating in the aqueous solution is recovered.

(10) The production method of water glass as described in (1) to (8) above, wherein when dissolving the silicon to generate a hydrogen gas, the entire amount of silicon in the sodium-based byproduct is dissolved.

(11) The production method of water glass as described in (1) to (10) above, wherein at least one of a sodium compound, a sodium silicate and a soluble silica is added before dissolving the sodium-based byproduct in water, after dissolving the sodium-based byproduct in water, or after the filtration and mixed with the sodium-based byproduct to adjust the molar ratio of water glass produced.

(12) The production method of water glass as described in (11) above, wherein at least one of the sodium compound, the sodium silicate and the soluble silica which are added before dissolving the sodium-based byproduct in water, after dissolving the sodium-based byproduct in water, or after the filtration is added in the state of a solid or an aqueous solution.

(13) The production method of water glass as described in (1) to (4) and (9) to (12) above, wherein the sodium-based byproduct when dissolving it in water is dissolved at a pressure in excess of atmospheric pressure.

(14) The production method of water glass as described in any one of (1) to (4) and (9) to (12) above, wherein the sodium-based byproduct when dissolving it in water is dissolved under atmospheric pressure and after generating a hydrogen gas, the sodium-based byproduct is further dissolved at a pressure in excess of atmospheric pressure.

### EFFECTS OF THE INVENTION

According to the present invention, a byproduct (sodium-based byproduct) which is by-produced in the process of enhancing the purity of silicon and not only contains silicon but also contains sodium silicate as a main component can be recycled, and transparent water glass can be produced from this sodium-based byproduct. Also, water glass production capable of solving the safety problem associated with hydrogen gas generation attributable to silicon contained in the byproduct can be achieved.

### BRIEF DESCRIPTION OF THE DRAWINGS

FIG. 1 is a schematic view of a typical production facility in which the production method of water glass of the present invention is implemented.

### MODE FOR CARRYING OUT THE INVENTION

The present invention provides a method for producing water glass by using a sodium-based by product which is by-produced in the process of enhancing the purity of silicon and not only contains silicon but also contains sodium silicate as a main component, where the silicon purity-enhancing process involving the production of the sodium-based byproduct includes, for example, the following two embodiments.

A first embodiment is a method for removing boron from metal silicon described in Kokoai No. 2005-247623 (Patent Document 1) (hereinafter referred to as a “boron removing method”), and this is a boron removing method of melting under heating metal silicon containing boron as an impurity and adding a solid based on silicon dioxide and a solid based on either one or both of sodium carbonate and hydrated sodium carbonate to the molten silicon to form a slag containing sodium silicate as a main component and at the same time, remove boron in the molten silicon by its transfer to the slag. In this method, the slag forms a mass containing sodium silicate as a main component and becomes a sodium-based byproduct named in the present invention.

A second embodiment is an SiO method described in Kokai No. 2004-51453 (Patent Document 2) (hereinafter referred to as an “SiO method”), where any one of oxides, hydroxides, carbonates and fluorides of sodium or two or more of these compounds are added to an SiO solid to obtain a mixture, and the mixture is heated at a temperature not lower than the melting point of Si, as a result, SiO is decomposed into Si and SiO₂ and at the same time, the produced SiO₂ reacts with the sodium compound to produce sodium silicate. At a temperature not lower than the melting point of Si, sodium silicate as well as Si are a liquid and therefore, coalesce with each other due to surface tension and after cooling, an Si mass and a mass containing sodium silicate as a main component are obtained. This sodium silicate mass is also a sodium-based byproduct named in the present invention.

The method for producing water glass from the sodium-based byproduct is described below.

The sodium-based byproduct is dissolved in water to form an aqueous solution and as described above, silicon contained in the sodium-based byproduct reacts with water to generate hydrogen to a greater or lesser extent. In the present invention, a water glass solution is produced while performing dehydration by separating the silicon or completely dissolving the silicon.

The general conditions in dissolving the sodium-based byproduct in water are preferably a pressure in excess of atmospheric pressure and most preferably a temperature of 120° C. or more, because at such a high pressure and a high temperature, dissolution of the sodium-based byproduct is accelerated and the produced suspended matter is granulated (crystal growth) to facilitate the filtration in the later stage. Furthermore, the granulated suspended matters are liable to be aggregated and forth an aggregate of approximately from 1 to 10 mm, making it easy to separate the aggregated suspended matter in the gravitational separation such as still standing and centrifugal separation. However, if the pressure is excessively high or the content of silicon in the sodium-based byproduct is large, a large amount of hydrogen is generated by the dissolution and sometimes becomes a problem. Accordingly, it is preferred to set an appropriate pressure condition by previously performing a dissolution test and confirming the generation of hydrogen. Incidentally, an autoclave can be used for the dissolution treatment at a pressure in excess of atmospheric pressure.

Another preferred condition is a condition in which the sodium-based byproduct is dissolved in water at 40° C. or more even under atmospheric pressure. As compared with a pressure in excess of atmospheric pressure, the dissolution rate is slightly low, but the sodium-based byproduct originally exhibits excellent solubility, and the operation in an actual machine is possible.

It is often preferred that the sodium-based byproduct is dissolved under atmospheric pressure (under, the condition of 100° C. or less) and then further dissolved at a pressure in excess of atmospheric pressure (or additionally at 120° C. or more). This is a method where the silicon contained in the sodium-based byproduct is reacted with hot water to generate hydrogen in the first dissolution treatment under atmospheric pressure and then, the sodium-based byproduct is completely dissolved or the suspended matter produced is granulated, at a pressure not lower than atmospheric pressure (or additionally at 120° C. or more) by using, for example, an autoclave, thereby facilitating the later-described filtration or the gravitational separation such as still standing or centrifugal separation. As a result of the first reaction of the majority or almost all of the silicon with water under atmospheric pressure, generation of hydrogen in the next autoclave treatment can be suppressed, and this is preferred in view of ensuring safety in the actual machine operation. In particular, this embodiment is preferred when using a sodium-based byproduct having a large silicon content.

The silicon contained in the sodium-based byproduct need not be entirely reacted with water. At the dissolution of the sodium-based byproduct, a hydrogen gas is generated from the silicon interface to collapse the sodium-based byproduct and separate silicon, and the separated silicon allows a hydrogen gas layer to adhere to the periphery of silicon. Accordingly, the silicon floats when the particle diameter is small, and remains precipitated when the particle diameter is large. The particle diameter with which the silicon floats or precipitates varies depending on the specific gravity of crude water glass in liquid form, the water temperature and the like and is not indiscriminately determined, but the particle diameter at the boundary between floating and precipitation is from 5 to 15 mm. By noting such behavior of silicon, i.e., the fact that the silicon is mostly present on the water surface and the bottom, the silicon can be separated by recovering the floating silicon and/or the silicon can be separated by collecting the crude water glass from the intermediate layer which is neither the water surface nor the bottom.

In some cases, the sodium-based byproduct fails in entirely dissolve at the stage of dissolving the sodium-based byproduct under atmospheric pressure or at a pressure in excess of atmospheric pressure. In such a case, the increase in the particle diameter due to crystallization (zeolite formation) of the suspended matter is insufficient and as a particle constituting the suspended matter, a particle of 1 μm or less is present in a large amount, giving rise to a large filtration resistance and a long filtration time at the filtration.

When the sodium-based byproduct is dissolved, the sodium silicate component dissolves in a few hours, but it takes a fairly long time for the contaminants (e.g., Al₂O₃, MgO, CaO) form a refractory liner, a member, a humidity retention material and the like to completely dissolve. For example, a part of the alumina component becomes aluminum hydroxide, and the aluminum hydroxide reacts with the dissolved sodium silicate component to form a gel of Na₂O—Al₂O₃-nSiO₂—H₂O. This gel allows zeolite crystallization through a hydrothermal synthesis reaction at 40 to 450° C. The crystallization time greatly varies depending on the temperature at the hydrothermal synthesis, and there is a tendency that as the temperature is lower, the crystallization requires a longer time. If the temperature is less than 60° C., the hydrothermal synthesis reaction (sometimes referred to as a “crystallization reaction”) requires 4 or more days and the productivity decreases, whereas if the temperature exceeds 250° C., the reaction time may be 30 minutes or less, but because of the batch operation in the reaction vessel as in an autoclave, an incidental work such as taking-in/taking-out of the crude water glass is involved, failing in yielding a great reduction of the entire cycle time, and at the same time, a pressure-resistant structure of about 4 MPa is necessary, which results in expensive equipment. For these reasons, the hydrothermal synthesis reaction is preferably performed at 60 to 250° C. Also, as described above, dissolution of the alumina component itself takes a very long time and therefore, in order to increase the particle diameter (1 μm or more) by crystallization in the state of an alumina component being present together, an unrealistically longer time (from a few days to 10 days) is required. Furthermore, the zeolite crystallized particle is readily aggregating and likely to form an aggregate of approximately from 1 to 10 mm. In addition, the contaminants above are mixed with the undissolved sodium-based byproduct, and it is difficult to separate the contaminants (e.g., Al₂O₃, MgO, CaO) from the undissolved sodium-based byproduct. In the case where the undissolved sodium-based byproduct is crystallized in the hydrothermal reaction region of 60 to 250° C. without separating it from the aqueous solution containing the gel, since the contaminants (e.g., Al₂O₃, MgO, CaO) are contained in the undissolved sodium-based byproduct, a gel is generated as described above and the gel generation continues until the soluble materials in the contaminants are dissolved. That is, a gel having a small particle diameter (<1 μm) is always produced and in the particle size distribution of the suspended matter composed of a gel or a crystallized particle, a fine particle (<1 μm) is contained in a ratio of 3 to 10%, resulting in that the aggregability, precipitability and filterability are poor. Therefore, the undissolved sodium-based byproduct containing the contaminants (e.g., Al₂O₃, MgO, CaO) is previously separated before entering the hydrothermal synthesis reaction region of 60 to 250° C., whereby new gel generation at the hydrothermal synthesis reaction is suppressed and the aggregability, precipitability and filterability are improved.

Accordingly, in the case where the sodium-based byproduct is not entirely dissolved in the stage of dissolving the sodium-based byproduct under atmospheric pressure or at a pressure in excess of atmospheric pressure, it is preferred that after separating the undissolved sodium-based product, i.e., after separating the undissolved sodium-based byproduct including the impurities (for example, an alumina component that takes time to dissolve), only water glass containing the suspended matter is again heated under atmospheric pressure or at a pressure in excess of atmospheric pressure to crystallize the suspended matter, thereby increasing the particle diameter. The thus-crystallized suspended matter has a property of readily undergoing aggregation and forms an aggregate of 1 to 10 mm. Thanks to crystallization and aggregation, the suspended matter can be easily separated in the later stage by filtration or gravitational separation such as still standing and centrifugal separation. Heating at atmospheric pressure is preferably performed under the condition of 40 to 100° C., and heating at a pressure in excess of atmospheric pressure is preferably performed at 120° C. or more by using, for example, an autoclave. As to the separation method of the undissolved sodium-based byproduct, for example, standing still, centrifugal separation or separation on a mesh can be employed.

The amount of the silicon contained in the sodium-based byproduct can be determined by finely pulverizing the sodium-based byproduct, then reacting it with warm or hot water at 40° C. or more, and measuring the amount of hydrogen generated there. At this time, hydrogen is considered to be generated according to formula (2) as the reaction formula.

Si(s)+2OH⁻+H₂O→SiO₃²⁻+2H₂(g)↑ (formula 2)

Incidentally, this reaction is preferably performed at about 40° C. or more. Although the reaction may proceed, for example, even at room temperature, the reaction proceeds very slowly, if at all.

After dissolving the sodium-based byproduct in water, filtration is preformed. The conditions of filtration are described below. In the filtration of water glass, a pressure filtration machine such as filter press is often used in industry. A vacuum/reduced-pressure filtration method may also be used. At the pressure filtration, the pressure is generally from 0.3 to 0.8 MPa (gauge pressure), and the temperature is preferably higher in so far as it is not more than the boiling point of the water glass. The viscosity of water glass is highly dependent on the temperature, and as the water glass temperature is higher, the viscosity is lower and the filtration is more facilitated. The temperature is preferably about 80° C.

As the method other than the temperature, the viscosity may also be controlled by adjusting the amount of water added when dissolving the sodium-based byproduct, i.e., by adjusting the concentration.

The turbidity of the water glass obtained after the filtration by the method above is preferably 15 or less. The water glass can be made colorless and transparent by decreasing the turbidity.

The molar ratio (SiO₂/Na₂O) of the sodium-based byproduct varies depending on whether the silicon purity-enhancing process is a boron removing method or an SiO method or depending on the operation conditions of the process, but the molar ratio may vary maximally in the range of approximately from 0.3 to 5 and usually varies from approximately 0.5 to 2.5.

The molar ratio of the sodium-based byproduct has a variation in this way and as for the molar ratio (SiO₂/Na₂O) of the water glass, those having various molar ratios can be used as a product. Therefore, for the purpose of adjusting this ratio, at least one of a sodium compound such as sodium hydroxide, a solid or solution of sodium silicate, and a soluble silica can be added before dissolving the sodium-based byproduct in water, after dissolving it in water, or after the filtration.

Incidentally, the soluble silica means a silica soluble in an alkali, which can be used when adjusting the molar ratio, and an amorphous silica such as white carbon, silica gel and diatomaceous earth is preferred because of its easy solubility. In the case of using a crystalline silica such as silica sand, this can be used if pulverized.

In adjusting the molar ratio, the method for adjusting the molar ratio of normal water glass can be applied.

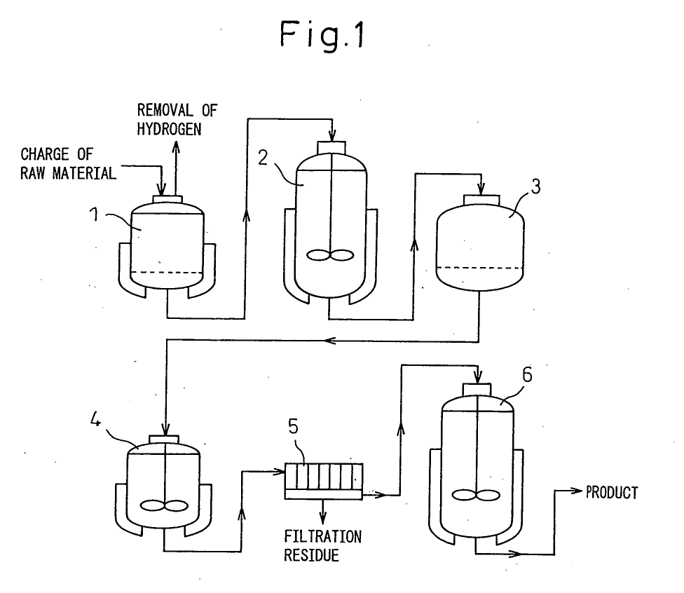

FIG. 1 shows one example of the facility used when implementing the production method of water glass of the present invention.

A sodium-based byproduct working out to a raw material and water are charged into a hydrogen removal tank 1, and the byproduct is dissolved while evacuating the tank. In this tank, the silicon and the alkali are thoroughly reacted, and removal of hydrogen is performed. Subsequently, the resulting solution is fed to a before-pressure-treatment adjusting tank 2, and concentration analysis and concentration adjustment are performed. The adjusted solution in the before-pressure-treatment adjusting tank 2 is charged into an autoclave 3 alone or together with the sodium compound or soluble silica described above for adjusting the molar ratio, and pressurized dissolution and ripening are performed. The solution after pressurization is charged into a before-filtration adjusting tank 4, and concentration analysis and concentration adjustment are performed. After removing suspended particles on a filter press 5, the clear solution is fed to a final product adjusting tank 6, and analysis and adjustment of the molar ratio and concentration are performed to obtain a final product. Incidentally, the above-described sodium compound, soluble silica or the like for adjusting the molar ratio is sometimes charged in any one of the hydrogen removing tank 1, the before-pressure-treatment adjusting tank 2, the before-filtration adjusting tank 4 and the final product adjusting tank 6.

### Examples

### Example 1

600 Gram of a sodium-based byproduct from the boron removing method and 1,200 g of water were charged into a stainless steel-made vessel and heated at 80° C. to generate hydrogen. After confirming that hydrogen bubbles were not generated, the entire amount was charged into an autoclave, water corresponding to the evaporated portion was added, and the sodium-based byproduct was dissolved at 150° C. and 0.37 MPa (gauge pressure) for 2 hours. The obtained crude water glass was suction-filtered using a filter cloth having an air permeability of 10 ({cm³/cm²·sec}, specified in JIS L 1096 “General Fabric Test Method”).

The liquid temperature at the initiation of filtration was set to 80° C., and the filtration pressure was set to 0.03 MPa (gauge pressure). The time required for the filtration was about 200 minutes. In the obtained water glass, Na₂O: 11.82 wt %, SiO₂: 20.53 wt %, molar ratio: 1.78, and turbidity: 10.

### Example 2

Crude water glass was produced by the same operation as in Example 1. To this crude water glass, 1 wt % of a filter aid was added, and filtration was performed in the same manner as in Example 1. The turbidity of the obtained water glass was 5 or less.

### Example 3

600 Gram of a sodium-based byproduct from the boron removing method and 1,200 g of water were charged into a stainless steel-made vessel and heated to a boiling state, thereby dissolving the sodium-based byproduct. After confirming that a mass of the sodium-based byproduct was not present, filtration was performed in the same manner as in Example 1. The turbidity of the obtained water galas was 15. Also, the filtration took as a long as 5 times that of Example 1.

### Example 4

100 Kilogram of a sodium-based byproduct from the boron removing method and 200 kg of water were charged into an autoclave and heated at 80° C. with the top cover open (under atmospheric pressure) to generate hydrogen. After confirming that hydrogen bubbles were not generated, water corresponding to the evaporated portion was added, the top cover of the autoclave was closed, and the sodium-based byproduct was dissolved at 150° C. and 0.37 MPa (gauge pressure) for 2 hours. To the obtained crude water glass, 0.6 wt % of a filter aid (diatomaceous earth) was added, and the crude water glass was pressure-filtered on a filter press using a filter cloth having an air permeability of 10. The liquid temperature at the initiation of filtration was set to 80° C., and the filtration pressure was set to 0.5 MPa (gauge pressure). In the obtained water glass, Na₂O: 9.48 wt %, SiO₂: 19.70 wt %, molar ratio: 2.1, and turbidity: 5. At this time, the average particle diameter of the residue was 2.784 μm.

### Example 5

15 Gram of soluble silica was mixed with 100 g of water glass obtained in Example 2, and the soluble silica was dissolved at 80° C. Water glass where Na₂O:. 10.20 wt %, SiO₂: 30.80 wt %, molar ratio: 3.1 and turbidity: 10, was obtained.

### Example 6

300 Gram of a sodium-based byproduct from the boron removing method and 1,200 g of water were charged into a stainless steel vessel and heated at 80° C. to generate hydrogen. After confirming that hydrogen bubbles were not generated, the entire amount was charged into an autoclave together with water corresponding to the evaporated portion without separating the undissolved sodium-based byproduct. Subsequently, 300 g of water glass cullet having a molar ratio of 3.75 was charged into the autoclave, and these were dissolved at 150° C. and 0.37 MPa (gauge pressure) for 2 hours. The residual solid concentration in the obtained crude water glass was 70 g/L, and the proportion of particles having a diameter of 1 μm or less in the residual solid was 5% (on the volume basis) based on all residual solids. To this crude water glass, 1 wt % of a filter aid (diatomaceous earth) was added, and the crude water glass was suction-filtered using a filter cloth having an air permeability of 10. The liquid temperature at the initiation of filtration was set to 80° C., and the filtration pressure was set to 0.03 MPa. The filtration area was 78.5 cm², and the time required for the filtration was about 300 minutes. In the obtained water glass, Na₂O: 9.26 wt %, SiO₂: 24.07 wt %, molar ratio: 2.7, and turbidity: 5.

### Example 7

300 Gram of a sodium-based byproduct from the boron removing method and 1,200 g of water were charged into a stainless steel vessel and heated at 80° C. to generate hydrogen. After confirming that hydrogen bubbles were not generated, the mixture was left standing still for 1 minute, and the undissolved sodium-based byproduct was precipitated and separated. Thereafter, only the crude water glass containing a suspended matter was charged into an autoclave together with water corresponding to the evaporated portion. Furthermore, 300 g of water glass cullet having a molar ratio of 3.75 was charged into the autoclave, and these were dissolved at 150° C. and 0.37 MPa (gauge pressure) for 2 hours. The residual solid concentration in the obtained crude water glass was 11 g/L, and the proportion of particles having a diameter of 1 μm or less in the residual solid was 1.5% (on the volume basis) based on all residual solids. To this crude water glass, 1 wt % of a filter aid (diatomaceous earth) was added, and the crude water glass was suction-filtered using a filter cloth having an air permeability of 10. The liquid temperature at the initiation of filtration was set to 80° C., and the filtration pressure was set to 0.03 MPa. The filtration area was 78.5 cm², and the time required for the filtration was about 30 minutes. In the obtained water glass, Na₂O: 9.26 wt %, SiO₂: 24.07 wt %, molar ratio: 2.7, and turbidity: 5.

### Example 8

300 Gram of a sodium-based byproduct from the boron removing method and 1,200 g of water were charged into a stainless steel vessel and heated at 80° C. to generate hydrogen. After confirming that hydrogen bubbles were not generated, the mixture was left standing still for 1 minute, and the undissolved sodium-based byproduct was precipitated and separated. Thereafter, only the crude water glass containing a suspended matter was charged into a stainless steel vessel together with water corresponding to the evaporated portion, heated at 80° C. for 5 hours and then left standing still for 12 hours. The deposit was precipitated and separated, and only the supernatant was charged into an autoclave. Furthermore, 300 g of water glass cullet having a molar ratio of 3.75 was charged into the autoclave, and these were dissolved at 150° C. and 0.37 MPa (gauge pressure) for 2 hours. The residual solid concentration in the obtained crude water glass was 0.1 g/L, and the proportion of particles having a diameter of 1 μm or less in the residual solid was 80% (on the volume basis) based on all residual solids. To this crude water glass, 1 wt % of a filter aid (diatomaceous earth) was added, and the crude water glass was suction-filtered using a filter cloth having an air permeability of 10. The liquid temperature at the initiation of filtration was set to 80° C., and the filtration pressure was set to 0.03 MPa. The filtration area was 78.5 cm², and the time required for the filtration was about 20 minutes. In the obtained water glass, Na₂O: 9.27 wt %, SiO₂: 24.09 wt %, molar ratio: 2.7, and turbidity: 5 or less.

### Example 9

300 Gram of a sodium-based byproduct from the boron removing method and 1,200 g of water were charged into a stainless steel vessel and heated at 80° C. to generate hydrogen. After confirming that hydrogen bubbles were not generated, the mixture was left standing still for 1 minute, and the undissolved sodium-based byproduct was precipitated and separated. Thereafter, only the crude water glass containing a suspended matter was charged into an autoclave together with water corresponding to the evaporated portion, heated at 150° C. and 0.37 MPa (gauge pressure) for 2 hours and then left standing still for 12 hours. The deposit was precipitated and separated, and only the supernatant was charged into an autoclave. Furthermore, 300 g of water glass cullet having a molar ratio of 3.75 was charged into the autoclave, and these were dissolved at 150° C. and 0.37 MPa (gauge pressure) for 2 hours. The residual solid concentration in the obtained crude water glass was 0.1 g/L, and the proportion of particles having a diameter of 1 μm or less in the residual solid was 85% (on the volume basis) based on all residual solids. To this crude water glass, 1 wt % of a filter aid (diatomaceous earth) was added, and the crude water glass was suction-filtered using a filter cloth having an air permeability of 10. The liquid temperature at the initiation of filtration was set to 80° C., and the filtration pressure was set to 0.03 MPa. The filtration area was 78.5 cm², and the time required for the filtration was about 20 minutes. In the obtained water glass, Na₂O: 9.5 wt %,. SiO₂: 24.06 wt %, molar ratio: 2.7, and turbidity: 5 or less.

### Example 10

300 Gram of a sodium-based byproduct from the boron removing method and 1,500 g of water were charged into a stainless steel vessel and heated at 80° C. to generate hydrogen. After confirming that hydrogen bubbles were not generated, the mixture was left standing still for 1 minute, and the undissolved sodium-based byproduct was precipitated and separated. Thereafter, only the crude water glass containing a suspended matter was charged into an autoclave together with water corresponding to the evaporated portion, heated at 150° C. and 0.37 MPa (gauge pressure) for 2 hours and then left standing still for 12 hours, and the deposit was precipitated and separated to obtain crude water glass. The residual solid concentration in the obtained crude water glass was 0.1 g/L, and the proportion of particles having a diameter of 1 μm or less in the residual solid was 85% (on the volume basis) based on all residual solids. To this crude water glass, 1 wt % of a filter aid (diatomaceous earth) was added, and the crude water glass was suction-filtered using a filter cloth having an air permeability of 10. The liquid temperature at the initiation of filtration was set to 80° C., and the filtration pressure was set to 0.03 MPa. The filtration area was 78.5 cm², and the time required for the filtration was about 15 minutes. In the obtained water glass, Na₂O: 9.7 wt %, SiO₂: 20.15 wt %, molar ratio: 2.1, and turbidity: 5 or less. This water glass was transferred to a stainless steel vessel and concentrated under heating to obtain water glass. In the obtained water glass, Na₂O: 18.1 wt %, SiO₂: 36.1 wt %, molar ratio: 2.06, and turbidity: 5 or less.

### Example 11

400 Gram of a sodium-based byproduct from the boron removing method and 1,200 g of water were charged into a stainless steel vessel and heated at 80° C., as a result, the sodium-based byproduct was dissolved (collapsed) and at the same time, some of the silicon was floating. The floating silicon was recovered. Even after the recovery of floating silicon, the sodium-based byproduct was not completely dissolved and hydrogen bubbles were generated, but by recovering crude water glass from the middle section of the stainless steel vessel, crude water glass causing no generation of hydrogen and containing a suspended matter was obtained. This crude water glass was charged into an autoclave, heated at 150° C. and 0.37 MPa (gauge pressure) for 2 hours and then left standing still for 12 hours. The deposit was precipitated and separated, and only the supernatant was charged into an autoclave. Furthermore, 300 g of water glass cullet having a molar ratio of 3.75 was charged into the autoclave, and these were dissolved at 150° C. and 0.37 MPa (gauge pressure) for 2 hours. The residual solid concentration in the obtained crude water glass was 0.2 g/L, and the proportion of particles having a diameter of 1 μm or less in the residual solid was 83% (on the volume basis) based on all residual solids. To this crude water glass, 1 wt % of a filter aid (diatomaceous earth) was added, and the crude water glass was suction-filtered using a filter cloth having an air permeability of 10. The liquid temperature at the initiation of filtration was set to 80° C., and the filtration pressure was set to 0.03 MPa. The filtration area was 78.5 cm², and the time required for the filtration was about 20 minutes. In the obtained water glass, Na₂O: 9.4 wt %, SiO₂: 23.81 wt %, molar ratio: 2.7, and turbidity: 5 or less.

### Example 12

A test was performed under the same conditions as in Example 4, except that the sodium-based byproduct was a byproduct from the SiO method. In the obtained water glass, Na₂O: 10.0 wt %, SiO₂: 31.50 wt %, molar ratio: 3.3, and turbidity: 10.

### Example 13

4.9 Kilograms of a commercially available aqueous 48.5% sodium hydroxide solution, 4.3 kg of water glass (molar ratio: 2.1, Na₂O: 17.9 wt %, SiO₂: 36.4 wt %) produced under the same conditions as in Example 10, and 0.8 kg of water were added and heated to 80° C. while thoroughly stirring the mixture. The resulting solution was cooled to 55° C., and 0.1 kg of seed crystal of sodium metasilicate pentahydrate was added. After crystallization in a constant-temperature bath at 55° C. for 5 hours, solid-liquid separation was performed using a centrifugal filter, as a result, 2.83 kg of a transparent granular sodium metasilicate pentahydrate crystal was obtained.

As seen from the results in these Examples, by performing the method of the present invention, a sodium-based byproduct which is by-produced in the process of enhancing the purity of silicon can be effectively recycled as water glass. Also, it is revealed that hydrogen gas generation and transparentization, which are tasks to be solved when producing water glass from a sodium-based byproduct, can be overcome.

### INDUSTRIAL APPLICABILITY

According to the present invention, a byproduct (sodium-based byproduct) which is by-produced in the process of enhancing the purity of silicon and not only contains silicon but also contains sodium silicate as a main component can be recycled, and transparent water glass can be produced from this sodium-based byproduct. Industrial applicability of the present invention is clear.

1. A production method of water glass, comprising dissolving a sodium-based byproduct which is by-produced in the process of enhancing the purity of silicone and not only contains silicon but also contains sodium silicate as a main component, in water to produce crude water glass, at the same time, dissolving said silicon to generate a hydrogen gas, and then filtering said crude water glass to produce water glass.

2. The production method of water glass as claimed in claim 1, comprising dissolving a sodium-based byproduct which is by-produced in the process of enhancing the purity of silicone and not only contains silicon but also contains sodium silicate as a main component, in water to produce crude water glass, at the same time, dissolving said silicon to generate a hydrogen gas, and then filtering said crude water glass by using a filter aid to produce water glass.

3. The production method of water glass as claimed in claim 1, wherein said sodium-based byproduct is a byproduct which is by-produced in a method for removing boron from silicon by melting under heating metal silicon containing boron as an impurity and adding a solid based on silicon dioxide and a solid based on either one or both of sodium carbonate and hydrated sodium carbonate to said molten silicon to form a slag containing sodium silicate as a main component and at the same time, remove boron in said molten silicon by its transfer to said slag, and which comprises said slag.

4. The production method of water glass as claimed in claim 1, wherein said sodium-based byproduct is a byproduct which is by-produced in a method for producing Si by adding any one of oxides, hydroxides, carbonates and fluorides of sodium or two or more of these compounds to an SiO solid to obtain a mixture and heating the mixture at a temperature not lower than the melting point of Si to produce Si.

5. The production method of water glass as claimed in claim 1, wherein said sodium-based byproduct when dissolving it in water is dissolved under atmospheric pressure, the produced aqueous solution is left standing still, an undissolved sodium-based byproduct is precipitated and separated, and the aqueous solution after the separation is used as said crude water glass.

6. The production method of water glass as claimed in claim 5, wherein said aqueous solution after the separation of an undissolved sodium-based byproduct is heated at 60 to 250° C. to aggregate suspended matters produced in the aqueous solution at said dissolution, the suspended matter is separated, and the aqueous solution after the separation is used as said crude water glass.

7. The production method of water glass as claimed in claim 1, wherein said sodium-based byproduct when dissolving it in water is dissolved under atmospheric pressure, the produced aqueous solution is heated at 60 to 250° C. to aggregate suspended matters produced in the aqueous solution at said dissolution, the suspended matter and an undissolved sodium-based byproduct are separated, and the aqueous solution after the separation is used as said crude water glass.

8. The production method of water glass as claimed in claim 6, wherein still standing or centrifugal separation is used as the method for separating said suspended matter.

9. The production method of water glass as claimed in claim 1, wherein when dissolving said silicon to generate a hydrogen gas, silicon floating in the aqueous solution is recovered.

10. The production method of water glass as claimed in claim 1, wherein when dissolving said silicon to generate a hydrogen gas, the entire amount of silicon in said sodium-based byproduct is dissolved.

11. The production method of water glass as claimed in claim 1, wherein at least one of a sodium compound, a sodium silicate and a soluble silica is added before dissolving said sodium-based byproduct in water, after dissolving said sodium-based byproduct in water, or after said filtration and mixed with said sodium-based byproduct, to adjust the molar ratio of water glass produced.

12. The production method of water glass as claimed in claim 11, wherein at least one of said sodium compound, said sodium silicate and said soluble silica which are added before dissolving said sodium-based byproduct in water, after dissolving said sodium-based byproduct in water, or after said filtration, is added in the state of a solid or an aqueous solution.

13. The production method of water glass as claimed in claim 1, wherein said sodium-based byproduct when dissolving it in water is dissolved at a pressure in excess of atmospheric pressure.

14. The production method of water glass as claimed in claim 1, wherein said sodium-based byproduct when dissolving it in water is dissolved under atmospheric pressure and after generating a hydrogen gas, said sodium-based byproduct is further dissolved at a pressure in excess of atmospheric pressure.
